(19) United States
(12) Patent Application Publication
(10) Pub. No.: US 2015/0029117 A1
(43) Pub. Date: Jan. 29, 2015

(54) ELECTRONIC DEVICE AND HUMAN-COMPUTER INTERACTION METHOD FOR SAME

(71) Applicant: HON HAI PRECISION INDUSTRY CO., LTD., New Taipei (TW)

(72) Inventors: YI-AN CHEN, New Taipei (TW); CHIN-SHUANG LIU, New Taipei (TW); CHAN-YU LIN, New Taipei (TW)

(21) Appl. No.: 14/340,786

(22) Filed: Jul. 25, 2014

(30) Foreign Application Priority Data
Jul. 26, 2013 (TW) 102127007

(51) Int. Cl. G06F 3/041; G06F 3/0488

(52) U.S. Cl. CPC G06F 3/0416; G06F 3/04886
USPC 345/173

(57) ABSTRACT

An electronic device includes a display member rotatably coupled to a base member. A touchpad is located on a working surface of the base member. The touchpad includes a first touch area, a second touch area, and a third touch area. When the first touch area detects a palm touch gesture, the first touch area is disabled from sensing and recognizing any touch gestures and the second touch area and the third touch area are enabled to sense and recognize touch gestures. A human-computer interaction method is also disclosed.

### CROSS-REFERENCE TO RELATED APPLICATIONS

This application claims priority to Taiwan Patent Application No. 102127007 filed on Jul. 26, 2013 in the Taiwan Intellectual Property Office, the contents of which are hereby incorporated by reference.

### FIELD

The disclosure generally relates to electronic devices, and more particularly relates to electronic devices having a touchpad and human-computer interaction methods.

### BACKGROUND

A portable computing device, such as a notebook computer, often uses a touchpad as a “cursor navigator,” as well as a component for selecting functions, such as “select” and “confirm.” However, the conventional touchpad is small and incapable of recognizing more complex touch operations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is an isometric view of an embodiment of an electronic device.

FIG. 2 is a block diagram of the electronic device of FIG. 1.

FIG. 3 is a block diagram of an embodiment of a human-computer interaction system.

FIG. 4 illustrates an embodiment of a touchpad defining three touch areas.

FIG. 5 is a flowchart of an embodiment of a human-computer interaction method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

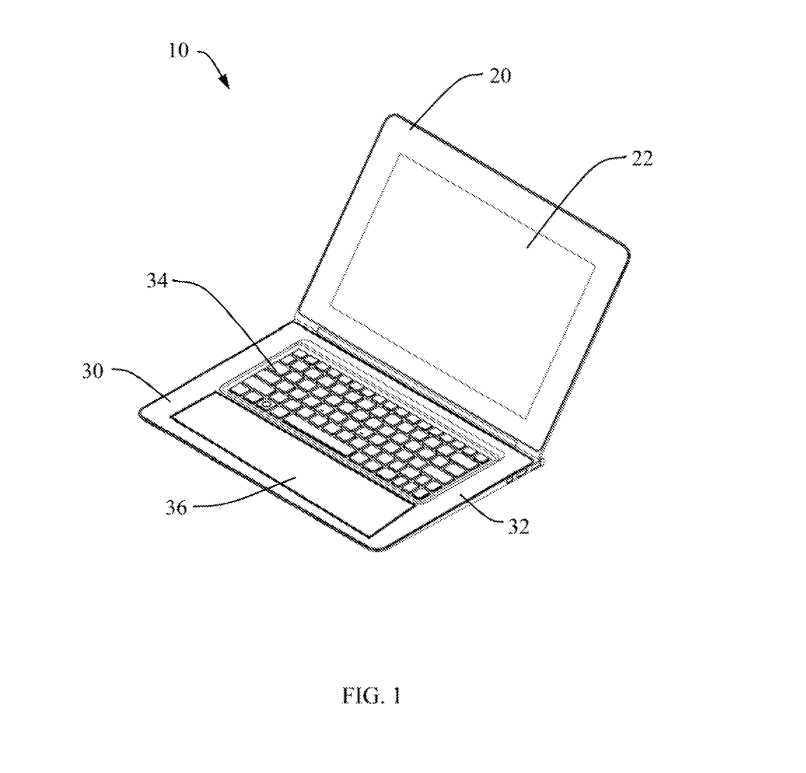

FIG. 1 illustrates an embodiment of an electronic device 10. The electronic device 10 can be, but is not limited to, a notebook computer, a tablet computer, a gaming device, a DVD player, a radio, a television, a personal digital assistant (PDA), a smart phone, or any other type of portable or non-portable electronic device.

The electronic device 10 includes a display member 20 pivotally connected to a base member 30, to enable variable positioning of the display member 10 relative to the base member 30. A display 22 is located on the display member 20. A keyboard 34 and a touchpad 36 are located on a working surface 32 of the base member 30. In the illustrated embodiment, the touchpad 36 is located adjacent to the keyboard 34.

In at least one embodiment, a length of the touchpad 36 is greater than 18 centimeters (cm), so that the touchpad 36 is suitable for two-hand operation by a user of the electronic device 10. In another embodiment, the length of the touchpad 36 is substantially the same as a length of the keyboard 34. In other embodiments, the length of the touchpad 36 is substantially the same as a length of the base member 30.

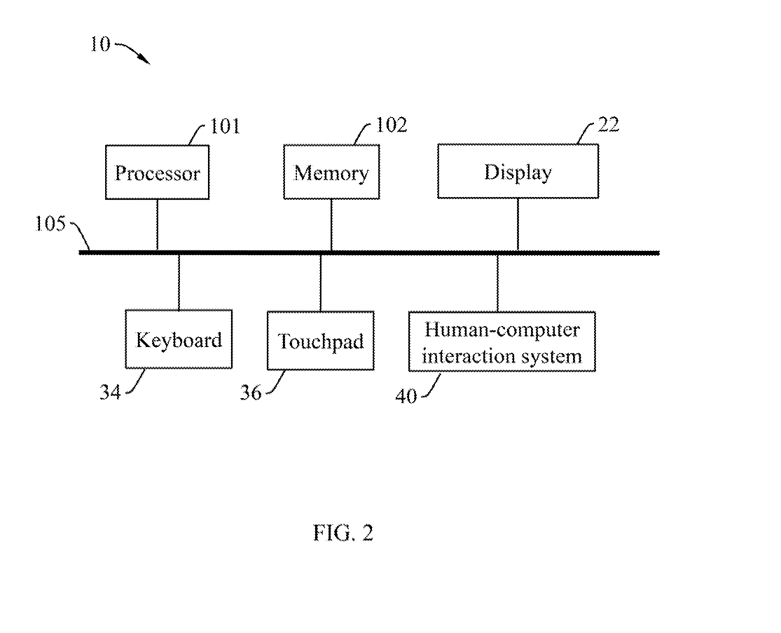

FIG. 2 illustrates a block diagram of an embodiment of the electronic device 10. The electronic device 10 includes at least one processor 101, a suitable amount of memory 102, a display 22, a keyboard 34, and a touchpad 36. The electronic device 10 can include additional elements, components, and modules, and be functionally configured to support various features that are unrelated to the subject matter described herein. In practice, the elements of the electronic device 10 can be coupled together via a bus or any suitable interconnection architecture 105.

The processor 101 can be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein.

The memory 102 can be realized as RAM memory, flash memory, EPROM memory, EEPROM memory, registers, a hard disk, a removable disk, a CD-ROM, or any other form of storage medium known in the art. The memory 102 is coupled to the processor 101, such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The display 22 can be suitably configured to enable the electronic device 10 to render and display various screens, GUIs, GUI control elements, menus, texts, or images, for example. The display 22 can also be utilized for the display of other information during operation of the electronic device 10, as is well understood.

The touchpad 36 can detect and recognize touch gestures input by a user of the electronic device 10. In one embodiment, the touchpad 36 includes a touch-sensitive surface made of carbon nanotubes.

A human-computer interaction system 40 can be implemented in the electronic device 10 using software, firmware, or other computer programming technologies.

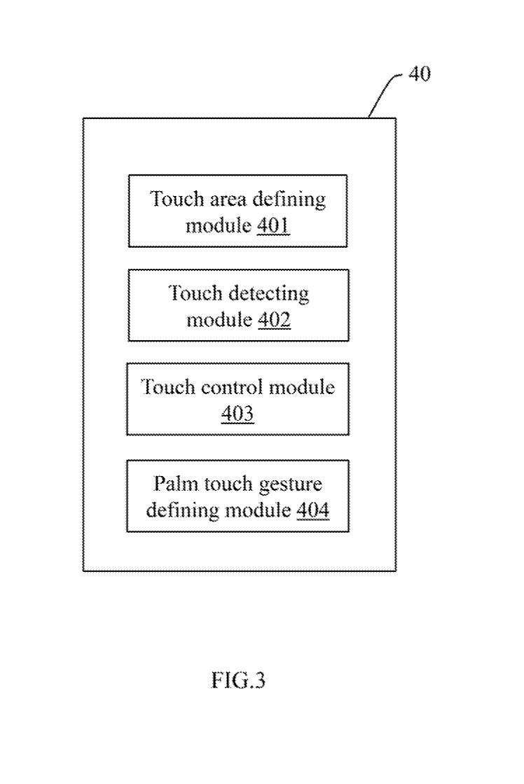

FIG. 3 illustrates a block diagram of an embodiment of the human-computer interaction system 40. The human-computer interaction system 40 includes a touch area defining module 401, a touch detecting module 402, a touch control module 403, and a palm touch gesture defining module 404.

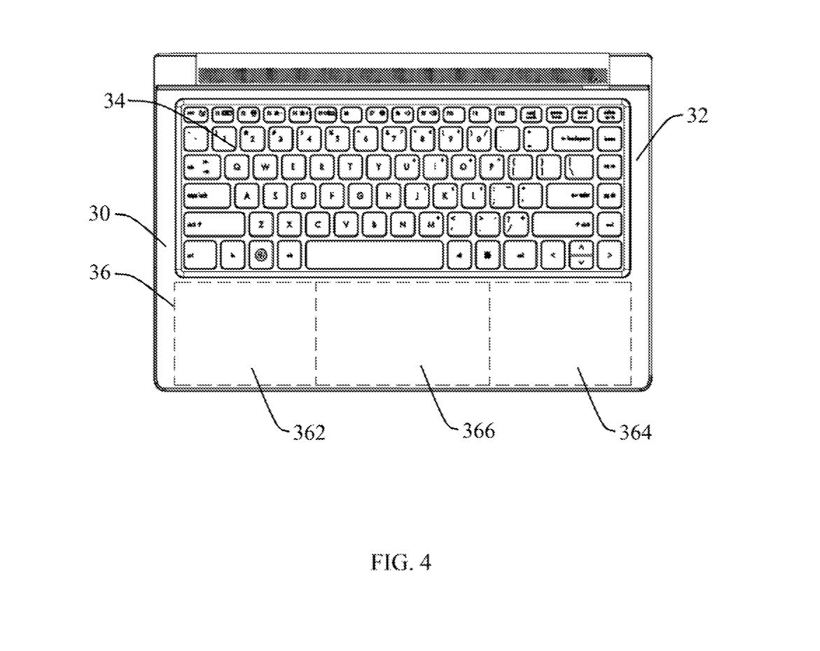

FIG. 4 illustrates an embodiment of a touchpad 36. The touch area defining module 401 can define a first touch area 362, a second touch area 364, and a third touch area 366 of the touchpad 36. In the illustrated embodiment, the first touch area 362 is located on a left side of the third touch area 366, and the second touch area 364 is located on a right side of the third touch area 366. In one embodiment, the first touch area 362 and the second touch area 364 are seamlessly connected to the third touch area 366.

The touch detecting module 402 can instruct the first touch area 362, the second touch area 364, and the third touch area 366 to sense and recognize touch gestures input by a user of the electronic device 10.

When the first touch area 362 detects a palm touch gesture, the touch control module 403 disables the first touch area 362 from sensing and recognizing any touch gestures, and enables the second touch area 364 and the third touch area 366 to sense and recognize touch gestures.

When the second touch area 364 detects a palm touch gesture, the touch control module 403 disables the second touch area 364 from sensing and recognizing any touch gestures, and enables the first touch area 362 and the third touch area 366 to sense and recognize touch gestures.

When the first touch area 362 and the second touch area 364 simultaneously detect a palm touch gesture, the touch control module 403 disables the first touch area 362 and the second touch area 364 from sensing and recognizing any touch gestures, and enables the third touch area 366 to sense and recognize touch gestures.

The palm touch gesture defining module 404 can provide a graphic user interface (GUI) displayed on the display 22 to allow a user to define a plurality of touch gestures corresponding to touch points of the touchpad 36, e.g., 40,000 touch points recognized as a palm touch gesture.

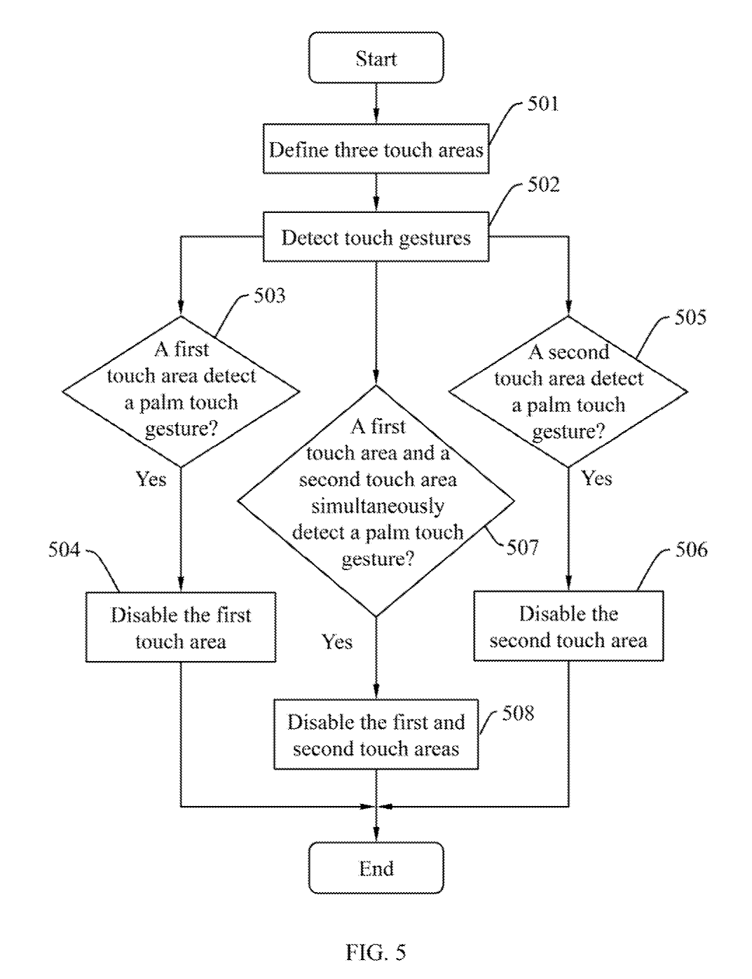

FIG. 5 illustrates a flowchart of one embodiment of a human-computer interaction method. The method includes the following steps.

In block 501, the touch area defining module 401 defines a first touch area 362, a second touch area 364, and a third touch area 366 in the touchpad 36. In one embodiment, the first touch area 362 is located on a left side of the third touch area 366, and the second touch area 364 is located on a right side of the third touch area 366. In other embodiments, the first touch area 362 and the second touch area 364 are seamlessly connected to the third touch area 366.

In block 502, the touch detecting module 402 instructs the first touch area 362, the second touch area 364, and the third touch area 366 to sense and recognize touch gestures input by a user of the electronic device 10.

In block 503, if the first touch area 362 detects a palm touch gesture, the flow proceeds to block 504.

In block 504, the touch control module 403 disables the first touch area 362 from sensing and recognizing any touch gestures and enables the second touch area 364 and the third touch area 366 to sense and recognize touch gestures.

In block 505, if the second touch area 364 detects a palm touch gesture, the flow proceeds to block 506.

In block 506, the touch control module 403 disables the second touch area 364 from sensing and recognizing any touch gestures and enables the first touch area 362 and the third touch area 366 to sense and recognize touch gestures.

In block 507, if the first touch area 362 and the second touch area 364 simultaneously detect a palm touch gesture, the flow proceeds to block 508.

In block 508, the touch control module 403 disables the first touch area 362 and the second touch area 364 from sensing and recognizing any touch gestures and enables the third touch area 366 to sense and recognize touch gestures.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

Although numerous characteristics and advantages have been set forth in the foregoing description of embodiments, together with details of the structures and functions of the embodiments, the disclosure is illustrative only, and changes may be made in detail, including in the matters of arrangement of parts within the principles of the disclosure. The disclosed embodiments are illustrative only, and are not intended to limit the scope of the following claims.

What is claimed is:

1. An electronic device, comprising:
a base member;
a display member rotatably coupled to the base member;
a touchpad located on a working surface of the base member, the touchpad comprising a first touch area, a second touch area, and a third touch area; and
a touch control module coupled to the touchpad, the touch control module configured to disables the first touch area from sensing and recognizing any touch gestures and enables the second touch area and the third touch area to sense and recognize touch gestures, after the first touch area detects a palm touch gesture.

2. The electronic device of claim 1, wherein the touch control module is further configured to disable the first touch area and the second touch area from sensing and recognizing any touch gestures and enable the third touch area to sense and recognize touch gestures, when the first touch area and the second touch area simultaneously detect a palm touch gesture.

3. The electronic device of claim 1, wherein the first touch area and the second touch area are located on two sides of the third touch area.

4. The electronic device of claim 3, wherein the first touch area and the second touch area are seamlessly connected to the third touch area.

5. The electronic device of claim 1, further comprising a palm touch gesture defining module configured to provide a graphic user interface (GUI) to allow defining a touch gesture corresponding to touch points recognized as the palm touch gesture.

6. The electronic device of claim 1, further comprising a keyboard located on the working surface of the base member, wherein the touchpad is adjacent to the keyboard.

7. The electronic device of claim 1, wherein the touchpad is suitable for two-hand operation by a user of the electronic device.

8. The electronic device of claim 1, wherein a length of the touchpad is substantially the same as a length of the keyboard.

9. The electronic device of claim 1, wherein a length of the touchpad is substantially the same as a length of the base member.

10. The electronic device of claim 1, wherein the touchpad comprises a touch-sensitive surface made of carbon nanotubes.

11. A human-computer interaction method implemented in an electronic device, the electronic device comprising a base member, a display member rotatably coupled to the base member, a touchpad located on a working surface of the base member, the human-computer interaction method comprising, comprising:
defining a first touch area, a second touch area, and a third touch area in the touchpad; and
when the first touch area detects a palm touch gesture, disabling the first touch area from sensing and recognizing any touch gestures and enabling the second touch area and the third touch area to sense and recognize touch gestures.

12. The human-computer interaction method of claim 11, further comprising:
when the first touch area and the second touch area simultaneously detect a palm touch gesture, disabling the first touch area and the second touch area from sensing and recognizing any touch gestures and enabling the third touch area to sense and recognize touch gestures.

13. The human-computer interaction method of claim 11, wherein the first touch area and the second touch area are located on two sides of the third touch area.

14. The human-computer interaction method of claim 13, wherein the first touch area and the second touch area are seamlessly connected to the third touch area.

15. The human-computer interaction method of claim 11, further comprising:
providing a graphic user interface (GUI) to allow defining a touch gesture corresponding to touch points recognized as the palm touch gesture.

16. The human-computer interaction method of claim 11, wherein the electronic device further comprises a keyboard located on the working surface of the base member, and the touchpad is adjacent to the keyboard.

17. The human-computer interaction method of claim 11, wherein the touchpad is suitable for two-hand operation by a user of the electronic device.

18. The human-computer interaction method of claim 11, wherein a length of the touchpad is substantially the same as a length of the keyboard.

19. The human-computer interaction method of claim 11, wherein a length of the touchpad is substantially the same as a length of the base member.

20. The human-computer interaction method of claim 11, wherein the touchpad comprises a touch-sensitive surface made of carbon nanotubes.
